(19) United States
(12) Patent Application Publication
(10) Pub. No.: US 2007/0158012 A1
(43) Pub. Date: Jul. 12, 2007

(54) Ultrasound welding device

(75) Inventors: Dietmar Heil, Dettighofen (DE); Pierre Bartholdi, Dielsdorf (CH)

Correspondence Address: WOOD, HERRON & EVANS, LLP, 2700 CAREW TOWER, 441 VINE STREET, CINCINNATI, OH, 45202, US

(73) Assignee: JENTSCHMANN AG ZURICH, Urdorf (CH)

(21) Appl. No.: 10/597,764

(22) PCT Filed: Jan. 17, 2005
(86) PCT No.: PCT/CH05/00018

§ 371 Date: Aug. 7, 2006

(30) Foreign Application Priority Data
Feb. 7, 2004 (CH) 187/04

(51) Int. Cl. B32B 37/00

(52) U.S. Cl. 156/73.1; 156/580.1; 156/555; 156/73.4

(57) ABSTRACT

The ultrasonic welding device (1) comprises a continuously operable roller sonotrode (13). The power of the roller sonotrode (13) may be closed-loop controlled depending on other welding parameter in a manner such that long welding seams or adhesive seam with a uniform quality may be manufactured. The method may be used for manufacturing canopies, tarpaulins, or pieces of clothing

### BACKGROUND OF THE INVENTION

The subject-matter is an ultrasonic welding device, a method for operating an ultrasound welding device as well as subjects manufactured according to this method, according to the features of patent claims 1, 5 and 8.

Ultrasonic welding is a joining technique with which e.g. thermoplastic or metallic subjects are connected to one another by supplying energy in the form of ultrasound or of high-frequency mechanical oscillation. A sonotrode which presses a first subject against a second subject is excited into oscillation in the ultrasonic range. By way of the transmission of the movement energy into the region of the border surface of both subjects, local frictional heat is produced which softens or melts the surfaces of the subjects and connects them together.

Ultrasonic welding technology amongst other things is used for connecting thermoplastic films or fabric. Apart from devices for the cyclic welding with which the high-frequency energy is transmitted in a pulsed manner by way of a die onto the subjects to be connected, ultrasonic welding devices for the continuous connection of thermoplastic films are already known. With this, the sonotrode is designed in the shape of a roller. The films to be connected are continuously moved between the rotating sonotrode wheel and a pressing wheel which is rotated synchronously in the opposite rotational direction, wherein a welding seam is formed which holds the two films together. A part of the welding device with the sonotrode and the pressing wheel may be moved relative to the stationarily held films for joining-together larger subjects or films. Many parameters such as e.g. the material of the films to be connected, the forward feed speed, the gap width between the sonotrode and the pressing wheel, the shaping and size of the pressing wheel, the pressing pressure of the sonotrode and the power supplied to the sonotrode influence the quality of the sear to be formed. The evaluation of suitable parameter constellations with continuously operated ultrasonic welding installations is unequally more difficult than with cycled ones. Furthermore, until now only relatively narrow welding seams could be formed which were insufficient for various applications. One disadvantage of such conventional continuously operated welding installations lies in the fact that fluctuation of quality of the formed seams may occur. Such seams in particular may have weak points at which the films are insufficiently welded to one another, but also regions, where the films e.g. are damaged or destroyed as a result of too great a development of heat.

### BRIEF SUMMARY OF THE INVENTION

It is the object of the present invention to provide a continuously operable ultrasonic welding device and a method for its operation as well as subjects manufacturable according to this method.

These objects are achieved by an ultrasound welding device and a method for operating an ultrasound welding device as well as by subjects, according to the preamble of the patent claims 1, 5 and 8.

The ultrasound welding device and the method according to the invention are based on the closed-loop control of the welding power of a roller sonotrode in dependence on welding parameters. They are suitable for welding or joining fabric-like or film-like subjects. Coated as well as uncoated subjects may thus be connected to one another. Even if these subjects have large dimensions and/or the joining locations or welding seams are very long, they may be regularly manufactured with a quality which remains the same. They may be manufactured with a uniform high strength and/or good sealing properties over the whole length of the seam, thus also in the edge regions. The pressing or compressing and simultaneous cooling of the seam after its manufacture is effected in a continuous manner directly following the seam formation location at the welding head. Thus large seam lengths with a uniform quality may be manufactured without interruption. The seam widths may be significantly larger than was previously possible until now, i.e. larger than about 11 mm. New applications open up by way of this. In only one [processing] passage one may create connections without problem for which previously two or more subsequent welding procedures were required. High quality weldings and bonds may be carried out in an inexpensive and efficient manner with the method according to the invention and with the device according to the invention. The processing speeds may be selected relatively large. Different, easily exchangeable guide apparatus may be attached in the region of the welding head. These assume the exact positioning and guiding of the weld seam or adhesive product on connection, seaming or depositing reinforcement strips. The guiding of the fabric may additionally or alternatively also be effected by way of guide rollers which may be lowered e.g. pneumatically. In particular double-sided, single-layer or multi-layer adhesive strips which may be activated by heat and/or pressure may likewise be positioned and guided by guiding apparatus on bonding. The welding head in a preferred embodiment is arranged in a traveling maimer along a long working table so that the length of a seam manufacturable in one working passage is essentially limited only by the length of the table. The rotation speeds of the roller sonotrode and of the counter pressure roller as well as the traveling speed of the welding head may be controlled independently of one another, wherein the advance [feed] ratio of the sonotrode to the counter pressure roller and the welding head may be programmed. The travel speed may in particular be synchronized with the weld speed. A welding without any slack and without the formation of undulations thus becomes possible. The setting of the individual speeds as well as the surface structure of the sonotrode may influence the quality of the seam, in particular its appearance. The measurement and/or programming and/or [open-loop] control and/or closed-loop control of various welding parameters such as e.g. welding energy, oscillation amplitude of the sonotrode, rotation speeds of the sonotrode and of the pressure roller, the traveling speed of the welding head, the gap width between the sonotrode and the pressure roller etc. may be effected in a manner such that an optimal bonding is possible for different subjects or subject combinations. Data or welding parameters for various applications with different materials and material qualities may be stored in a non-volatile manner, and when required, e.g. may be called up again for example in a menu-controlled manner or may be used for setting the welding device. Such data or welding parameters for the start phase and the end phase of the seam formation may differ from that of the phase lying between these. By way of the closed-loop control of the welding however one may prevent the films to be connected from melting in an uncontrolled maimer and the formation of aggressive or toxic vapors.

Furthermore the welding device according to the invention has low energy consumption. Power peaks may be avoided thanks to the closed-loop control in real time. One may also prevent changes in certain welding parameters during the welding procedure from leading to a change of the seam quality. The ultrasonic welding device according to the invention may e.g. be used for welding or bonding thermoplastic films or tarpaulin [covers] or of fabrics coated with thermoplasts such as PVC. Uncoated substances such as e.g. acrylic which is widely used in the manufacture of canopies may be connected without any problem by way of hot-melt adhesives Possible applications for example are the manufacture of films, canopies, tarpaulin [covers], pieces of clothing, etc.

### BRIEF DESCRIPTION OF THE DRAWINGS

The invention is described in more detail by way of a few figures. With this there are shown in:

FIG. 1 a schematic representation of an ultrasonic welding device,

FIG. 2 a longitudinal section of the device from FIG. 1 in the region of the sonotrode,

FIG. 3 a principle schematic diagram of the device,

FIG. 4 a schematic representation of the device in the region of the press device.

### DETAILED DESCRIPTION OF THE INVENTION

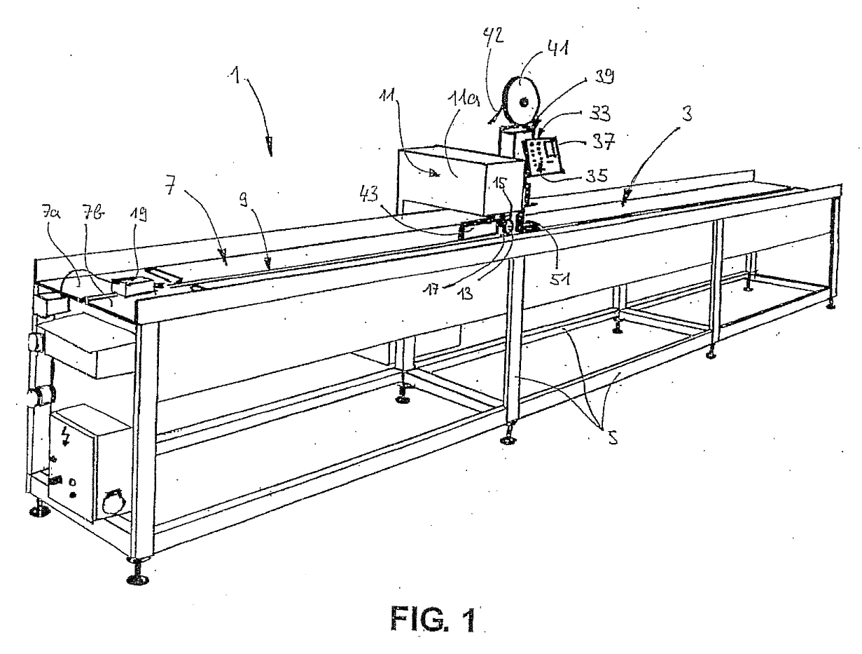

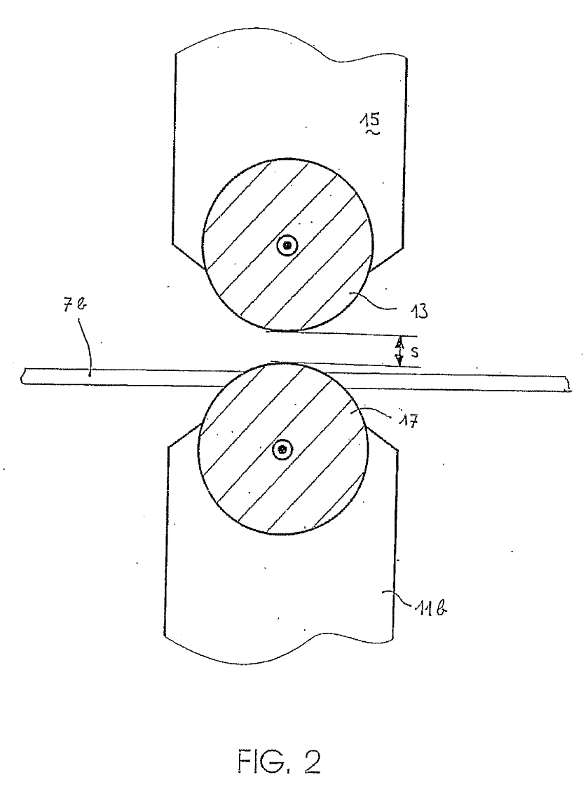

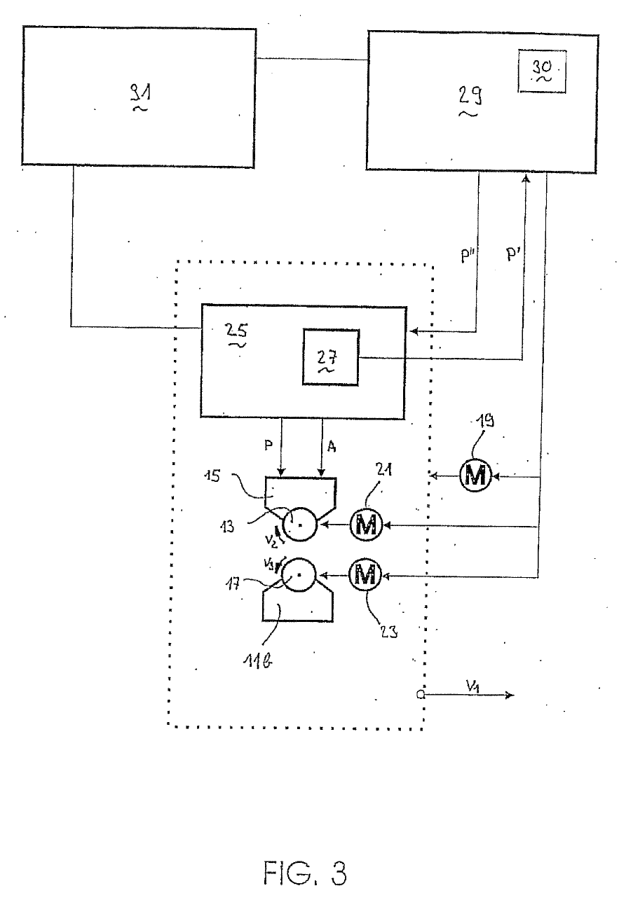

FIG. 1 in a schematic representation shows an ultrasonic welding device in a first design. The welding device 1 comprises the following elements (not a complete listing):
A long working table with a stable framing 5 of aluminum profiles and a horizontal working plate 7 which centrally is divided into two part plates 7a, 7b by way of a gap 9 running in the longitudinal direction.
An L-shaped or C-shaped carrier 11 which is displaceably guided on guide rails (not shown) in the longitudinal direction.
A welding head with a wheel-like roller sonotrode, called sonotrode 13 for short, which is rotatably held on a sonotrode arm 15 over the gap 9. The welding head may be lowered or lifted in settable positions or attitudes along a guide (not shown) formed on the upper arm 11a, e.g. by way of a pneumatic drive. If the sonotrode 13 rests on a subject the contact pressure or the contact force may be detected e.g. by way of a pressure sensor. The contact pressure, indicated in FIG. 3 at “p” may thus be [open-loop] controlled and/or closed-loop controlled. The sonotrode according to the invention may have a significantly larger effective width than was possible until now, e.g. 12 mm, 15 mm, 20 mm.
An anvil in the form of counter-pressure roller or pressure roller 17 which is arranged parallel to the axis below the sonotrode 13 and serves as an abutment element for the subjects to be joined on pressing from the opposite side by way of the sonotrode 13. (Of course alternatively the anvil may be movable and the sonotrode position fixed). The pressure roller 17 is rotatably arranged on a carnage (not shown) which is synchronously displaceable with the carrier 11 or on the lower arm 11b (FIG. 2) of the carrier 11. It projects from below into the gap 9. The periphery or roller surface of the pressure roller 17 projects beyond the upper side of the working plate 7 or is arranged flush to this.
A first drive 19 for displacing or traversing the carrier 11 at a speed v₁ in the longitudinal direction of the working table 3, a second drive 21 (FIG. 3) for rotating the roller sonotrode 13 at a first surface speed v₂ and a third drive 23 for rotating the pressure roller 17 at a third speed v₃, wherein these drives 19, 21, 23 are preferably electrical servomotors. The first drive 19 may e.g. be fixedly arranged in the end region of the working table 3, wherein an endless toothed belt connected to the carrier 11 or a similar transmission element may convert the rotational movement into a translation movement of the carrier (no representation). The second drive 21 may e.g. be coaxially connected to the sonotrode 12 and drive this directly Preferably it is arranged in the region of the sonotrode arm 15 such that the rotational movement may be transmitted onto the rotation axis of the roller sonotrode 12 by way of gearing up or down. The third drive 23 may be actively connected to the pressure wheel 17 in an analogous manner.
Generator electronics, called generator 25 for short, for producing the high-frequency activation power for the excitation of the sonotrode 13. The generator 25 comprises a power sensor 27 or a similar detection means which emits an analog or digital signal which corresponds to the electrical power consumption [P] of the generator 25.
A main control, called control 29 for short, for the [open-loop] control and/or closed-loop control of the generator 25 in dependence on setting values or required or command variables and measured or control variables. In particular, the control 29 is designed in a manner such that it may detect the power P′ supplied by the generator 25 to the sonotrode 13 or (if information on the efficiency of the sonotrode is present, i.e. on the ratio of the power supplied to the subject by the sonotrode to the electrical power consumed by the sonotrode) the power delivered to the subject by the sonotrode 13 as a measured variable or control variable. Furthermore the control 29 comprises a preferably non-volatile memory 30 in which different combinations of welding parameters and/or further variables may be stored. Suitable data or alternatively data functions or courses dependent on time and position which favor or ensure the manufacture of high-quality seams with a uniform strength and sealedness may thus for example be stored for various combinations of subjects to be joined. A few examples of such data are cited hereinafter, wherein the possible value range is specified in square brackets:
   the welding power P″ as a command variable as a percentage of the maximal welding power: 75% [50% . . . 100%], wherein the maximal welding power may for example be 500 W, 600 W, 750 W, 900 W or 1 kW,
   regulating variable(s): amplitude A [amplitude A, pressure p]
   welding speed v₁: 0.1 m/s [0.05 m/s . . . 0.35 m/s]
   total welding duration: 5 s [0.1 s . . . 100 s]
   total seam length: 4.9 m [0.01 m . . . 20 m]
   lower and upper limit of the applicable range of the respective data set (as a % of the total seam length or of the total welding duration): 5%/95% [0% . . . N %/N % . . . 100%], wherein N: [0 . . . 100]
   material thickness of the lower subject: 0.1 mm [0.1 mm . . . 10 mm]
   material thickness of the upper subject: 0.1 mm [0.1 mm . . . 10 mm]
   type of necessary adhesive strip as an intermediate layer: 0 [0, 1, 2, . . . 100] (an allocation table with detail specifications such as description, layer thickness etc. may likewise be stored).

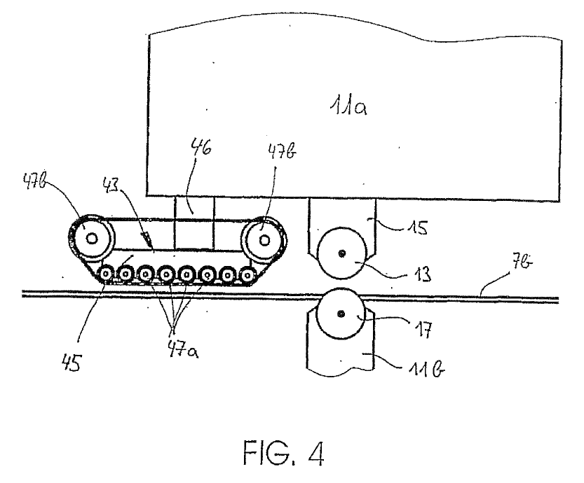

The control 29 for example may compute a suitable gap width s (FIG. 2) between the sonotrode 13 and the pressure roller 17 from such data. Alternatively this gap width s may also be set as a storable parameter. This gap width s may serve as a border value on welding or adhering which may not be fallen short of. The control 29 monitors the gap width s or a measurable equivalent variable and may use this as an additional criteria for influencing e.g. the sonotrode amplitude or the speeds of one or more of the drives 19, 21, 23. With a particularly advantageous design of the invention, a distance sensor (no representation) which may e.g. be held on the lower side of the upper arm 11a or on the sonotrode arm 15 detects the distance to the upper side of the subjects to be joined just in front of the weld location. If the material thickness suddenly changes, thus for example on crossing a reinforcement strip or in the region of a seam, the welding parameters including the welding power may be automatically adapted and modified for this region according to a settable pattern for this region.
A mains part for providing the energy supply in particular of the generator 25, the control 29 and the electrical drives 19, 21, 23 and, as the case may be, of further components which are operated with electrical energy.
An operating device 33 with operating elements 35 (e.g. a keyboard) and with a display 37 which are preferably designed for a menu-controlled operation.
Optionally, an easily assemblable roller holder which may be removed again, for accommodating an adhesive tape roller
A continuously operable press device 43. This as is schematically shown in FIG. 4 may be a parallelepiped metal body 45 with a press arm 46 which analogously to the sonotrode 13 and the sonotrode arm 15 may be pneumatically positioned in the vertical direction and impinged with pressure. Several small metal rollers 47a with good heat conduction properties and which are rowed onto one another at a small mutual distance are held freely rotatably on the metal body 45 on the lower longitudinal side of the metal body 45. A deflection roller 47b with a larger diameter is in each case rotatably held on the metal body 45 at the two narrow sides by way of a (non-shown) fastening or tensioning device, wherein these deflection rollers 47b project laterally and upwards beyond the metal body 45. An endless belt 49 is tensioned around the metal rollers 47a and the deflection rollers 47b in a manner similar to the caterpillar of a caterpillar track vehicle, which preferably has good heat conducting properties, a high mechanical stability and a high flexibility, e.g. a steel belt. In an analogous manner a counter-pressure belt manner may be arranged flush with the upper side of the working plate 7 (no representation) on the opposite side, thus in the gap 9. The press device 43 may additionally be cooled with pressurized air or with another means.
Optionally, one or more easily exchangeable guiding apparatus 51. A holding device (not shown) for one or more guide apparatus 51 is provided in the region of the welding head. For seaming one may e.g. use a guide apparatus 51 into which one edge of the subject film is bent over or inserted in a folded manner and may be clamped rigidly between two plates equipped with rollers. The clamping may be effected by way of spring force or by way of pressurized air. The deflection device (no representation) on the entry side ensures than with the travel of the carrier 11 the material edge is continuously bent over and introduced into the clamping device in a positionally accurate manner. If the seam is bonded by way of a holt-melt adhesive, the guide apparatus 51 may additionally comprise a feed device (no representation) for the positionally-accurate introduction of a double-sided, single-layer or multi-layer adhesive tape 42 which may be activated by way of pressure and/or heat and which may be drawn from a supply roller 41. The adhesive tape 42 in contrast to conventional hot-melt adhesive methods may be exactly aligned before the adhesive effect begins due to the supply of energy by way of the sonotrode 13.

With wide sonotrodes 12 one may form seams and margins with which the adhering (gluing) is uniformly distributed onto the whole width of the seam or margin. The heating is furthermore effected from the inside, thus at the border layers between the film or fabric and the adhesive tape. A damage or even destruction of the subject films on account of excess supply of heat from the outside may therefore be avoided. The same applies also to the supply and conveyor apparatus 51 for the reinforcement strips or for connecting film or fabric webs.

With a further formation of the invention, as for example may be used e.g. for manufacturing smaller subjects such as rain clothing, the carrier 11 is stationary with the welding head, thus may not be moved. The material to be welded may e.g. be manually guided through the welding location. In this manner one may create seams of any shape. At the same time the welding speed may be influenced by way of a foot controller similar to a sewing machine, or another suitable setting means. Additionally a picture sensor, e.g. a sensor as is applied with an optical mouse may detect the amount and/or direction of the movement of the material to be welded and this measured variable may be taken into account as a further parameter with the closed-loop control of the welding power.

1-10. (canceled)

11. An ultrasonic welding device for joining together fabric-like or film-like subjects, comprising a continuously drivable roller sonotrode and an anvil arranged opposite the roller sonotrode, wherein the distance between the roller sonotrode and the anvil may be changed, and wherein the subjects may be pressed together between the roller sonotrode and the anvil and may be joined together by way of introducing ultrasonic oscillation via the sonotrode, wherein the welding power of the roller sonotrode may be closed-loop controlled by way of a control.

12. An ultrasound welding device according to claim 1, wherein the amplitude of the activation signal for the sonotrode and/or the pressing pressure or the contact force of the sonotrode onto the subjects are regulating variables for the closed-loop control of the welding power.

13. An ultrasonic welding device according to claim 1, wherein the desired welding power or the ratio of the desired welding power to the maximal possible welding power may be programmed or stored as required values or command variables.

14. An ultrasonic welding device according to claim 1, wherein the sonotrode has an effective width which is larger than 11 mm.

15. A method for operating an ultrasonic welding device according to claim 1, wherein the welding power or its dependence as a function of time or of the path is programmed or stored as a command variable.

16. A method according to claim 5, wherein the welding power is closed-loop controlled.

17. A method according to claim 5, wherein a double-sided adhesive strip with a hot-melt adhesive is activated by energy transmission from the sonotrode.

18. Subjects manufacturable with the method according to any one of claims 1-7, wherein these comprise a welding seam or an adhesive seam with a uniform quality.

19. Subjects according to claim 8, wherein the welding seam or adhesive seam has the width of more than 11 mm.

20. Subjects according to claim 8, wherein these have the form of tarpaulin or canopies or pieces of clothing.
